(19) United States
(12) Patent Application Publication
(10) Pub. No.: US 2011/0033608 A1
(43) Pub. Date: Feb. 10, 2011

(54) PROCESS FOR MAKING COATED, WATER-SWELLABLE HYDROGEL MICROSPHERES

(75) Inventors: Garret D. Figuly, Wilmington, DE (US); Henricus Jacobus Cornelis Gommeren, Hockessin, DE (US); Guangliang Liu, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/920,618

(22) PCT Filed: Mar. 6, 2009
(86) PCT No.: PCT/US2009/036284

§ 371 Date: Sep. 2, 2010

Related U.S. Application Data
(60) Provisional application No. 61/068,316, filed on Mar. 6, 2008.

(51) Int. Cl. B05D 7/00

(52) U.S. Cl. 427/2.1; 427/213

(57) ABSTRACT

A process for coating water-swellable hydrogel microspheres with various coating materials is described. The coating process described herein is a fluidized bed process, which utilizes inert, cofluidization particles to aid the fluidization of the microspheres. The use of the cofluidization particles increases the efficiency of the coating process and improves the quality of the coating obtained.

### CROSS-REFERENCE TO RELATED APPLICATION

This application claims priority under 35 U.S.C. §119 from U.S. Provisional Application Ser. No. 61/068,316, filed Mar. 6, 2008.

### FIELD OF INVENTION

The invention relates to hydrogel microspheres. More specifically, the invention relates to a process for coating water-swellable hydrogel microspheres using a fluidized bed coater.

### BACKGROUND OF THE INVENTION

Hydrogel microspheres have many potential applications, including medical applications. For example, microspheres with high density, yet a large capacity to swell in an aqueous environment, are useful for absorption applications such as small-scale spill control and for delivery applications in which they carry and release active ingredients such as fertilizers, herbicides, pesticides, cosmetics, and shampoos. Medical applications of hydrogel microspheres include tissue augmentation, void filling, wound treatment, embolization, and drug delivery. Tissue augmentation involves introduction of materials in a collapsed area to provide a filling function, such as the treatment of scars or wrinkles. Void filling involves introduction of materials into an empty space, such as one created by removal of a tissue mass. Wound treatment involves introduction of materials to stop bleeding, provide padding, deliver medication, and absorb fluids. Such materials are useful especially in emergency situations including accidents and military operations. Embolization treatment involves the introduction of a material into the vasculature in order to block the blood flow in a particular region, and may be used to treat non-cancerous tumors, such as uterine fibroids, and cancerous tumors, as well as to control bleeding caused by conditions such as stomach ulcers, aneurysms, and injury. Blockage may be desired in the case of arteriovenous malformation (AVM), where abnormal connections occur between arteries and veins. Additionally, blockage may be desired for pre-surgical control of blood flow.

For many applications, it may be desirable to add functional layers to the microspheres using various coating techniques. Examples of functional layers include layers of drugs or other therapeutic agents for drug delivery, layers to control the swell of the microspheres, layers to provide a tracer for improved detection, barrier layers, degradable layers with embedded actives for controlled release, layers to provide a non-stick surface, and layers for particle shape and size control. Fluidized bed coating methods are well suited to applying these functional layers onto hydrogel microspheres (see for example Harder et al., U.S. Patent Application Publication No. 2006/0088476, Engelhardt et al., U.S. Pat. No. 6,150,477, and Sun et al., J. Controlled Release 47:247-260, 1997). Fluidized bed coating transfers small amounts of material dissolved or dispersed in droplets to the surface of the microspheres, which results in an accurate layer-by layer application. Although the fluidized bed coating method provides many advantages for coating hydrogel microspheres, further improvements in coating efficiency and coating quality, such as, preventing agglomeration and swelling, are needed.

Therefore, the problem to be solved is to provide a method for efficiently coating water-swellable, hydrogel microspheres which overcomes agglomeration and prevents swelling. The stated problem is addressed herein by the discovery of a process for coating water-swellable hydrogel microspheres which utilizes inert, cofluidization particles to aid the fluidization of the microspheres. The use of the cofluidization particles increases the efficiency of the coating process and improves the quality of the coating obtained.

### SUMMARY OF THE INVENTION

In various embodiments, the invention provides a process for coating water-swellable, hydrogel microspheres with various coating materials using a fluidized bed coater. The process utilizes inert, cofluidization particles having specific properties to aid the fluidization of the microspheres.

Accordingly in one embodiment, the invention provides a process for making coated water-swellable, substantially water-free hydrogel microspheres from starting microspheres having a preselected diameter range from dₘᵢₙ to dₘₐₓ, and a preselected swell initiation time with a nonvolatile coating material comprising the steps of:
(a) providing a coating material carrier medium by mixing the coating material with an aqueous medium comprising volatile components;
(b) providing a dry mixture comprising the starting microspheres and cofluidization particles having a diameter range from Dₘᵢₙ to Dₘₐₓ, wherein Dₘᵢₙ is at least larger than dₘₐₓ and a density that allows the dry mixture to form a fluidized bed in step (c);
(c) exposing the dry mixture to a stream of flowing gas in a chamber at a temperature sufficiently high to evaporate the volatile components of the aqueous medium in a time less than the preselected swell initiation time, thereby forming the fluidized bed comprising the dry mixture;
(d) atomizing the coating material carrier medium into the chamber containing the fluidized bed for a time sufficient to provide the coated microspheres; and
(e) optionally repeating step (d) one or more times with the same or different coating material carrier medium; and
(f) separating the coated microspheres from the cofluidization particles.

### BRIEF DESCRIPTION OF THE FIGURES

FIG. 1 displays two electron micrographs showing a comparison of the surface smoothness of coated microspheres (A), prepared as described in Example 3, with uncoated microspheres (B).

FIG. 2 is graph of the cumulative release profile of aspirin from the coated microspheres described in Example 4.

FIG. 3 is graph of the cumulative release profile of BSA from the coated microspheres described in Example 5.

FIG. 4 is graph of the cumulative release profile of BSA from the coated microspheres described in Example 6.

FIG. 5 is graph of the cumulative release profile of aspirin from the coated microspheres described in Example 7.

### DETAILED DESCRIPTION OF THE INVENTION

Disclosed herein is a process for coating water-swellable hydrogel microspheres with various coating materials using a fluidized bed coater. The process utilizes inert, cofluidization particles having specific properties to aid the fluidization of the microspheres. The cofluidization particles enhance the fluidity of the hydrogel microspheres, break up agglomerates that may be present in the hydrogel microspheres, prevent agglomeration of the hydrogel microspheres during coating, and improve the coating quality.

The coating process disclosed herein can be used to apply various functional layers to the microspheres for a variety of applications, including, but not limited to, absorption applications, such as small-scale spill control; delivery application to carry and release active ingredients such as fertilizers, herbicides, pesticides, cosmetics, and shampoos; and medical applications such as tissue augmentation, void filling, wound treatment, embolization, and drug delivery.

The following definitions and abbreviations are to be used for the interpretation of the claims and the specification.

The term “microspheres” or “microsphere” refers to either a population of micron size particles, or an individual particle, depending upon the context in which the word is used, which has a high sphericity measurement. The sphericity measurement of a population of microspheres may be in the range of about 80% to about 100%, with 95% being typical. The microspheres are substantially spherical, although a microsphere population may include some individual particles that have a lower sphericity measurement.

The term “water-swellable hydrogel microspheres” refers to microspheres which are substantially water-insoluble and are capable of absorbing a substantial amount of water, thereby increasing in volume when contacted with water or an aqueous medium.

The term “water-swellable, substantially water-free hydrogel microspheres” refers to water-swellable hydrogel microspheres that contain little or no water and therefore are present in a substantially unswollen state. A small amount of water may be present in the water-swellable, substantially water-free hydrogel microspheres, typically about 1% to about 10% of the total weight of the microspheres. Although a small amount of water may be present in the substantially water free hydrogel microspheres, the microspheres flow when tilted or swirled in a container and thus form a free-flowing microsphere powder.

The term “starting microspheres” refers to water-swellable hydrogel microspheres that are the starting material for the coating process disclosed herein.

The term “preselected swell initiation time” refers to the time at which the water-swellable hydrogel microspheres first begin to swell after contact with water or an aqueous medium.

The term “preselected diameter range” refers to the size range of the starting microspheres to be coated by the process disclosed herein. The starting microsphere samples have a preselected diameter range from a minimum diameter (dₘᵢₙ) to a maximum diameter (dₘₐₓ), depending on the intended application. Microspheres may be separated by methods such as screen sieving, also called screen filtering, and air-jet sieving, to obtain starting microspheres having the desired preselected diameter range.

The term “coating material carrier medium” refers to a liquid medium prepared by mixing the coating material to be coated onto the microspheres with an aqueous carrier medium. The coating material carrier medium may be in the form of a solution or dispersion.

The term “cofluidization particles” refers to inert particles that are used in the coating process disclosed herein to aid the fluidization of the microspheres to be coated. The cofluidization particles may comprise any suitable material, including but not limited to, polymers, metallic coated particles, metal oxides, glasses, and the like, and have a diameter range from Dₘᵢₙ to Dₘₐₓ, wherein Dₘᵢₙ is at least larger than the maximum diameter of the starting microspheres (dₘₐₓ).

The meaning of abbreviations used is as follows: “min” means minute(s), “h” means hour(s), “sec” means second(s), “μL” means microliter(s), “mL” means milliliter(s), “L” means liter(s), “nm” means nanometer(s), “mm” means millimeter(s), “cm” means centimeter(s), “cm³” means cubic centimeters, “μm” means micrometer(s) or micron(s), “mM” means millimolar, “M” means molar, “g” means gram(s), “mol” means mole(s), “Mol %” means mole percent, wt %” means percent by weight, “rpm” means revolutions per minute, “psi” means pounds per square inch, “g” means the gravitation force, “BSA” means bovine serum albumin, “PBS” means phosphate-buffered saline.

### Starting Microspheres

The starting microspheres suitable for use in the process disclosed herein are water-swellable hydrogel microspheres. The starting microspheres comprise various polymers which are typically crosslinked, although uncrosslinked polymers may also be used. The polymer composition of the starting microspheres may be chosen from a wide variety of polymers known in the art depending on the intended application. Examples of polymer compositions of the starting microspheres include, but are not limited to, polymers comprising at least one monomer selected from the group consisting of acrylic acid, methacrylic acid, salts (such as sodium and ammonium) of acrylic acid and methacrylic acid, acrylamide, methacrylamide, N-substituted acrylamides, N-substituted methacrylamides, vinyl alcohol, vinyl acetate, methyl maleate, 2-acryloylethane-sulfonic acid, 2-methacryloylethane-sulfonic acid, salts of 2-acryloylethane-sulfonic acid and 2-methacryloylethane-sulfonic acid, styrene-sulfonic acid, salts of styrene-sulfonic acid, 2-hydroxyethyl acrylate, 2-hydroxyethyl methacrylate, isobutylene, maleic anhydride, acrylonitrile, and ethylene glycol. Other suitable polymers include saponification products of copolymers of vinyl acetate and acrylic acid ester, vinyl acetate and acrylic acid ester copolymer, vinyl acetate and methyl maleate copolymer, isobutylene-maleic anhydride crosslinked copolymer, starch-acrylonitrile graft copolymer and its saponification products, and crosslinked polyethylene oxide. Most useful starting microspheres for medical applications comprise monomers having biocompatibility such as acrylic acid, methacrylic acid, salts of acrylic acid and methacrylic acid, 2-hydroxyethyl acrylate and 2-hydroxyethyl methacrylate, and combinations thereof.

In one embodiment, the polymer composition of the starting microspheres is a combination comprising acrylic acid and at least one monomer from the group of sodium acrylate, 2-hydroxyethyl methacrylate, 2-hydroxyethyl acrylate, styrene sulfonic acid, and the sodium salt of styrene sulfonic acid.

In one embodiment, the polymer composition of the starting microspheres is a combination comprising acrylic acid and sodium acrylate.

In another embodiment, the polymer composition of the starting microspheres comprises styrene sulfonic acid or a combination comprising styrene sulfonic acid and the sodium salt of styrene sulfonic acid.

In another embodiment, the polymer composition of the starting microspheres comprises acrylic acid, sodium acrylate and vinyl alcohol.

The starting microspheres may be prepared using methods known in the art, such as those described by Kitagawa (U.S. Pat. No. 6,218,440), Vogel et al. (U.S. Pat. No. 6,218,440), Hori et al. (JP 06056676), Horak et al. (Biomaterials 7:188-192, 1986), and Lewis et al. (U.S. Patent Application Publication No. 2006/0204583). In one embodiment, the starting microspheres are prepared by the method described by Figuly et al. (U.S. Patent Application Publication No. 2007/0237956, particularly paragraphs 0050 to 0068). That process makes use of a water soluble, low temperature-active azo initiator in an aqueous solution of monomer, crosslinking agent, and emulsifier. A chlorinated organic medium, for example a chloroform and methylene chloride mixture, is used in forming a suspension with the aqueous solution. The aqueous solution and organic medium both additionally include protecting colloids. The aqueous solution and organic medium, as well as the mixture of the two, are initially held below the initiation temperature of the azo initiator. Then, the temperature is raised to activate the azo initiator causing polymerization to produce microspheres. The resulting microspheres have properties of general consistency in size and shape, high density, low fracture, high swell capacity, rapid swell, and deformability following swell.

After preparation, the starting microspheres may be dried to form a powder of microspheres. Drying rids the microspheres of remaining washing solvent and additional water. Drying may be by any standard method such as using air, heat, and/or vacuum. Particularly useful is drying under vacuum in a vacuum oven set at about 20° C. to about 100° C. with a nitrogen purge. A small amount of water generally remains in the microspheres after drying. The amount of remaining water may be about 1% to about 10% of the total weight of the microspheres.

Microspheres prepared using methods known in the art are typically heterogeneous mixtures having a range of particle sizes. The starting microspheres useful in the coating process disclosed herein have a size range of about 10 microns to about 1,000 microns in diameter. For use in the coating process, the starting microspheres are separated into microsphere samples having a preselected diameter range from a minimum diameter (dₘᵢₙ) to a maximum diameter (dₘₐₓ), depending on the intended application. Microspheres may be separated by methods such as screen sieving, also called screen filtering, or air-jet sieving. Particularly useful is sieving through a series of sieves appropriate for recovering samples containing microspheres of desired sizes. For example, separate samples of microspheres may be obtained using a series of sieves with mesh sizes of 35 to 400 mesh. Separate microsphere samples may be obtained that have diameters ranging between about 30 and about 44 microns; about 115 and about 165 microns; about 180 and about 330 microns; and with size ranges also falling between and outside of these exemplary groups.

In one embodiment, the starting microspheres have a preselected diameter range from dₘᵢₙ of about 20 microns to dₘₐₓ of about 800 microns.

In another embodiment, the starting microspheres have a preselected diameter range from dₘᵢₙ of about 25 microns to dₘₐₓ of about 250 microns.

The starting microspheres have a preselected swell initiation time, which can be determined by measuring the time at which the microspheres first begin to swell when exposed to water or an aqueous medium, as described in the General Methods section of the Examples herein below. Typically, the starting microspheres exhibit rapid swell. Individual microspheres may reach a maximum size within about 15 seconds of contacting the microsphere with water. Thus, the individual microspheres reach their full swell capacity within about 15 seconds, and typically within about 10 seconds. The swell initiation time of individual microspheres is typically in the range of about 1 second to about 5 seconds.

### Coating Materials

Coating materials used in the process disclosed herein are nonvolatile materials so that they are not evaporated during the coating process. The nonvolatile coating material may serve as a functional layer to provide microspheres having improved properties and/or functionality for various applications. Examples of functional layers include, but are not limited to, layers of drugs or other therapeutic agents for drug delivery, layers to control the swell of the microspheres, layers to provide a tracer for improved detection, barrier layers, degradable layers with embedded actives for controlled release, layers to provide a non-stick surface, and layers for particle shape and size control. The coating material may be any suitable material including, but not limited to, a drug or therapeutic agent, a biological material, a hydrophilic polymer, a hydrophobic polymer, a monomer such as those listed above for the microsphere compositions; a marker such as a colored dye, a fluorescent dye, or radio opaque marker; a carbohydrate, a polysaccharide, a wax, an inorganic material, and combinations thereof.

Any suitable pharmaceutical drug or therapeutic agent may be used as a coating material depending on the intended application. Suitable pharmaceutical drugs and therapeutic agents are well known in the art. An extensive list is given by Kabonov et al. in U.S. Pat. No. 6,696,089 (in particular, columns 16 to 18). Examples include, but are not limited to, antibacterial agents, antiviral agents, antifungal agents, anti-cancer agents, vaccines, anti-inflammatories, anti-glaucomic agents, analgesics, local anesthetics, anti-neoplastic agents, anti-angiogenic agents, and the like.

Suitable biological materials for use as a coating material include, but are not limited to, proteins, peptides, nucleic acids, antibodies, hormones, lipids, cell adhesion promoters, and the like.

A variety of polymers may be used as the coating material depending on the function desired. For example, a degradable polymer may be used in combination with a drug or therapeutic agent for controlled release. The drug or therapeutic agent may be embedded in the polymer layer or the degradable polymer layer may be coated over a drug or therapeutic agent layer. Additionally, an elastomeric material, such as that described by Fossum et al. (U.S. Pat. No. 7,049,000) may be coated onto the starting microspheres in order to control expansion. Hydrophilic or hydrophobic polymers may be used as the coating material to alter the surface properties of the starting microspheres. Suitable polymers for use as the coating material include, but are not limited to, cellulose esters such as cellulose acetate, cellulose benzoate, and cellulose butyrate; cellulose ethers such as 2-hydroxybutylmethyl cellulose, 2-hydroxyethyl cellulose, 2-hydroxyethyl ethyl cellulose, 2-hydroxyethyl methyl cellulose, 2-hydroxypropyl cellulose, 2-hydroxypropyl methyl cellulose, dimethoxyethyl cellulose acetate, ethyl 2-hydroxylethyl cellulose, ethyl cellulose, ethyl cellulose sulfate, ethylcellulose dimethylsulfamate, methyl cellulose, methyl cellulose acetate, methylcyanoethyl cellulose, sodium carboxymethyl 2-hydroxyethyl cellulose, and sodium carboxymethylcellulose; polycarbonates; polyurethanes; polyvinyl acetates; polyvinyl alcohols; polyvinyl pyrrolidones, fluoropolymers such as polytetrafluoroethylene, polyvinylfluoride, and polyvinylidene fluoride; polyamides; polyesters; polysiloxanes such as poly(dimethylsiloxane); poly acrylic acid derivatives such as polyacrylates, polymethyl methacrylate, poly(acrylic acid) higher alkyl esters, and poly(ethylmethacrylate); polyethers such as poly(octyloxyethylene), poly(oxyphenylethylene), poly(oxypropylene), poly(oxyethylene), poly(pentyloxyethylene), poly(phenoxy styrene), poly(secbutroxylethylene), and poly(tert-butoxyethylene); and copolymers and polymer blends thereof.

The coating material may also be an inorganic material such as a metal, a salt, or an inorganic barrier such as clay.

The coating material may also be an active agent such as a fertilizer, a herbicide, a pesticide, a cosmetic agent, and the like.

### Process for Making Coated Water-Swellable Hydrogel Microspheres

The process for making coated water-swellable, substantially water-free hydrogel microspheres disclosed herein utilizes a fluidized bed coater, also known as an air suspension coater or Wurster coater (a type of fluidized bed coater which utilizes spraying at the bottom with a draft tube), which is well known in the art (see for example, Hall et al., The Wurster Process, in Controlled Release Technologies: Methods, Theory, and Applications, Kydonnieus, Ed., Vol. II, CRC Press, Boca Raton, Fla., 1980, pp. 133-154; and Lehmann, Fluidized-Bed Spray Coating, in Microcapsules and Nanoparticles in Medicine and Pharmacy, Donbrow, Ed., CRC Press, Boca Raton, Fla., 1991, pp. 73-97). Suitable fluidized bed coaters are available commercially from companies such as The Lasko Co. (Leominster, Mass.), Glatt AG. (Germany), and Applied Chemical Technology, Inc. (Florence, Ala.).

In the process disclosed herein, the coating material, as described above, is provided in a coating material carrier medium, which is prepared by mixing the desired coating material with an aqueous medium comprising volatile components. The coating material carrier medium may be in the form of a solution or dispersion. The aqueous medium may be water or a mixture of water and a volatile, water-miscible organic solvent such as aliphatic alcohols, polyhydric alcohols, amides, ketones, and the like. In one embodiment, the aqueous medium is water. A combination of different coating materials may be mixed with the aqueous medium to form the coating material carrier medium, for example a combination of a marker and a drug, or a combination of a drug and a degradable polymer for controlled release of the drug. The volatile components are evaporated during the coating process and are not coated onto the water-swellable hydrogel microspheres. The coating material carrier medium may also comprise various additives depending on the intended application. Suitable additives include, but are not limited to, surfactants, buffers, anti-foam agents, stabilizers, antimicrobial agents, antistatic agents, anti-stick agents (e.g., oils to minimize agglomeration), dyes and/or pigments, and the like.

A dry mixture of the starting microspheres, described above, and cofluidization particles is provided. The cofluidization particles are inert particles having a diameter range from Dₘᵢₙ to Dₘₐₓ, wherein Dₘᵢₙ is at least larger than dₘₐₓ, the maximum diameter of the starting microspheres. Cofluidization particles in this size range are readily separated from the coated microspheres after the process is completed, as described below. The cofluidization particles may be sized using methods known in the art, such as screen sieving, to obtain the desired particle size range. The cofluidization particles may comprise any suitable material, including but not limited to, polymers, metallic coated particles, metal oxides, glasses, and the like. Preferably, the cofluidization particles are mechanically stable so that they do not break apart during the coating process. Additionally, the cofluidization particles have a density that allows the dry mixture to form a fluidized bed. The required particle density for any particular system may be determined by one skilled in the art using routine experimentation.

In one embodiment, the cofluidization particles are substantially spherical in shape.

In one embodiment, the cofluidization particles have a diameter range from Dₘᵢₙ of 100 microns to Dₘₐₓ of 1,000 microns.

In another embodiment, the cofluidization particles have a diameter range from Dₘᵢₙ of 100 microns to Dₘₐₓ of 500 microns.

In another embodiment, the cofluidization particles have a diameter range from Dₘᵢₙ of 300 microns to Dₘₐₓ of 500 microns.

In one embodiment, the cofluidization particles are polymeric particles, such as polystyrene.

In one embodiment, the cofluidization particles are polystyrene particles having a diameter range from Dₘᵢₙ of 360 microns to Dₘₐₓ of 500 microns.

In another embodiment, the cofluidization particles are polystyrene particles having a diameter range from Dₘᵢₙ of 425 microns to Dₘₐₓ of 500 microns.

The cofluidization particles may be mixed with the starting microspheres in various ratios. For example, the cofluidization particles may be mixed with the starting microspheres in ratios of weight percent (cofluidization particles/starting microspheres) ranging from about 95%/5% to about 30%/70%, preferably from about 90%/10% to about 80%/20%. The optimum ratio to use for any particular application can be readily determined by one skilled in the art using routine experimentation.

The dry mixture is exposed to a stream of flowing gas, for example an inert gas such as nitrogen, in a chamber (i.e., in a fluidized bed reactor) at a temperature sufficiently high to evaporate most of the volatile components of the aqueous medium in a time less than the preselected swell initiation time, thereby forming a fluidized bed comprising the dry mixture. In this way, no substantial swelling of the microspheres occurs during the coating process. The temperature required to evaporate the volatile components of the aqueous medium in a time less than the preselected swell initiation time and the conditions necessary to form the fluidized bed, for example, gas flow rate and initial bed height, can be readily determined by one skilled in the art using routine experimentation. The temperature required will depend of the preselected swell initiation time of the starting microspheres, as well as the composition of the aqueous medium. Guidance for the selection of a suitable temperature for the stream of flowing gas is provided in the Examples herein below, in which temperatures of 122° F. (50° C.) to 160 F. (71.1° C.) are demonstrated for acrylic acid/sodium acrylate hydrogel microspheres prepared by the method of Figuly et al., supra, and water as the aqueous medium.

Then, the coating material carrier medium is atomized using an atomizing nozzle (e.g., a bi-fluid nozzle) into the chamber containing the fluidized bed for a time sufficient to provide the coated microspheres. The time required to obtain the desired coating depends on a number of factors including, the spray rate of the carrier medium, the amount of starting microspheres used in the process, and the coating thickness desired, and may be readily determined by one skilled in the art using routine experimentation. The spray rate of the carrier medium is controlled by the evaporation rate of the volatile components in the aqueous medium. The size of the atomized droplets is typically less than 20 microns in order to provide a smooth coating.

The atomization step may be repeated one or more times with the same or a different coating material carrier medium to coat multiple layers on the microspheres. The layers may be of the same coating material or different coating materials. For example, a layer of one drug may be followed by a layer of a second drug, or a layer of a drug may be followed by a layer of a degradable polymer for controlled release of the drug.

After completion of the coating process, the resulting coated water-swellable, substantially water-free hydrogel microspheres are separated from the cofluidization particles using methods known in the art, for example screen sieving. Some coatings may need further curing steps to form smooth coating layers. Then, the coated microspheres are used for their intended application, for example, absorption applications, such as small-scale spill control; delivery application to carry and release active ingredients such as fertilizers, herbicides, pesticides, cosmetic agents, and shampoos; and medical applications such as tissue augmentation, void filling, wound treatment, embolization, and drug delivery.

### EXAMPLES

The present invention is further defined in the following Examples. These Examples are given by way of illustration only, and should not be construed as limiting. From the above discussion and these Examples, one skilled in the art can ascertain the essential characteristics of this invention, and without departing from the spirit and scope thereof, can make various changes and modifications of the invention to adapt it to various uses and conditions.

### General Materials and Methods

Chemicals, solvents, and other ingredients were purchased from Aldrich (Milwaukee, Wis.) and used as received, unless otherwise specified. The VA-044 polymerization initiator was used as received from Wako Pure Chemical Industries, Ltd (Richmond, Va.).

### Preparation of Starting Microspheres:

Microspheres were prepared using the method described by Figuly et al. in U.S. Patent Application Publication No. 2007/0237956. A typical preparation is described here.

In a 5 L round-bottom, three-necked flask equipped with an overhead stirrer, thermometer, reflux condenser, and nitrogen inlet port was prepared a solution of 36.0 g ethyl cellulose, 1200 mL of chloroform, and 570 g of methylene chloride (solution A). The mixture was stirred at 100 rpm until the ethyl cellulose dissolved; then the agitator was increased in speed to 180 rpm to create a slight vortex. In a second flask, was prepared a solution of 1.50 g methyl cellulose, 3.00 g N,N′-methylenebisacrylamide (2.3 Mol % of monomer), 26.01 g Triton™ X-405 (polyoxyethylene (40) isooctylphenyl ether—70% solution in water), and 149.4 g water (solution B). In a third separate flask was mixed 58.5 g of acrylic acid and 81 g of a 25% aqueous sodium hydroxide solution (to reach a pH between 5 and 6) (solution C). This acrylic acid solution was then added to the water solution B.

At this point, while rapidly stirring the mixture of Solutions B and C, 0.15 g of the water-soluble azo initiator VA-044 (2,2′-azobis(2-[2-imidazolin-2-yl])propane dihydrochloride) was added, and the resulting solution was stirred for 5 min. This solution (the “first solution”) was then added to the round-bottom flask containing solution A (the “second solution”). The resulting reaction mixture was allowed to stir (the “first suspension”) at 180 rpm for about 1 h at room temperature. The first suspension was then heated to 51° C. and stirred at 180 rpm for an additional 10 hours at that temperature to allow substantial microsphere formation (the “second suspension”). The second suspension was then stirred at 180 rpm for another 14 hours at room temperature to ensure complete polymerization. After this time, approximately 1200 mL of methanol was slowly added to the second suspension to remove water from the microspheres, and the microspheres were allowed to stir an additional hour. The microspheres were then filtered and washed with an additional 250 mL of methanol. They were filtered again and finally washed with 250 mL of ethanol. They were then dried in a nitrogen purged vacuum oven set at 100° C. The resulting microspheres were white in color. The final yield of dried microspheres was 73.4 g.

The resulting dried microspheres exhibited diameters generally ranging from 25 microns to 250 microns as measured from photos acquired via scanning electron microscopy. Microsphere swell was tested as described by Figuly et al., supra. When exposed to water, the microspheres absorbed 89 g of water/g of microspheres.

The time required for the microspheres to swell was determined as follows. The microspheres were placed on a glass slide that was then placed under a microscope lens. A drop of water was placed on the slide. Movement of the water front across the slide was observed via a high speed multiple exposure digital camera, taking pictures at 2 frames per second. The images were recorded, as well as the time it took for the water front to move across the slide. The microspheres reached nearly maximal size in 4 sec. After 14 sec only a slight increase in microsphere size was observed. This method may also be used to determine the swell initiation time of the microspheres.

Sphericity measurements of microspheres were made on a bulk scale using the Beckman-Coulter™ RapidVUE® particle analysis system (Hialieah, Fla.), using an adaptive threshold value of 56%. A 20 mg sample of microspheres was suspended in 75 mL of water (swelled microspheres), a 50 mg sample of microspheres was suspended in 75 mL of DMSO (unswelled microspheres), and both samples were assayed in the particle analyzer. The results showed that both swelled and unswelled microspheres were close to spherical with a measured sphericity centered near 95%, indicating a high degree of sphericity for the microspheres prepared by the process described above.

### Example 1

### Coating of Water-Swellable Hydrogel Microspheres with a Polymer for Controlled Expansion

The purpose of this Example was to demonstrate coating of water-swellable hydrogel microspheres with a layer of ethylcellulose, a hydrophobic coating material, to control expansion of the microspheres when exposed to an aqueous medium.

A coating material carrier medium was prepared by mixing 425 g of Aquacoat® ECD, a 30 percent by weight aqueous dispersion of ethylcellulose polymer (FMC Biopolymer, Philadelphia, Pa.); 31.6 g of ATEC plasticizer (acetyl triethyl citrate, Morflex Inc., Greensboro, N.C.); and 88 g of deionized water in a 1-L beaker using a magnetic stirrer for 24 hours.

A dry mixture was prepared by mixing together 19 g of the starting microspheres (unsieved having a preselected diameter range of about 25 μm to about 250 μm), prepared using the method described in General Methods, and 180 g of polystyrene cofluidization particles having a diameter range of 360 μm to 500 μm, density of 1.05 g/cm³ (Norstone Inc., Wyncote, Pa., used as received).

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 42 feet/min with an inlet heating temperature set at 136° F. (57.8° C.) to form a fluidized bed.

When the outlet gas temperature reached 85° F. (29.4° C.), the coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 3 mL/min and a nozzle atomizing nitrogen pressure of 20 psi. After the entire coating material carrier medium was atomized, the pump was turned off and the fluidized bed was maintained at 140° F. (60° C.) for 20 min to dry the coated microspheres. Then, the heater was turned off and the fluidized bed was maintained for another 5 min to cool the coated microspheres.

The coated microspheres were collected and then sieved using a 250 μm screen to separate them from the cofluidization particles. The coated microspheres were placed into an oven at 62° C. for 25 hours to cure the coating polymer.

The time required for the coated microspheres to reach substantially maximum size when exposed to water was tested as described in General Methods and compared with the time required for uncoated microspheres. The coated microspheres exhibited a delay of about 10 min before reaching maximum size, while the uncoated microspheres reached maximum size within about 14 sec, demonstrating the controlled expansion due to the presence of the polymer coating.

### Example 2

### Coating of Water-Swellable Hydrogel Microspheres with a Colored Dye Marker

The purpose of this Example was to demonstrate coating of water-swellable hydrogel microspheres with a blue colored marker dye.

A coating material carrier medium was prepared by mixing 0.2 g of Severn Blue dye (Standard Dyes Inc.) and 199.8 g of deionized water in a 1-L beaker using a magnetic stirrer for several minutes.

A dry mixture was prepared by mixing together 15 g of the starting microspheres (unsieved having a preselected diameter range of about 25 μm to about 250 μm), prepared using the method described in General Methods, and 185 g of polystyrene cofluidization particles having a diameter range of 360 to 500 μm, density of 1.05 g/cm³ (Norstone Inc., Wyncote, Pa., used as received).

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 55 feet/min with an inlet heating temperature set at 160° F. (71.1° C.) to form a fluidized bed.

When the outlet gas temperature reached 85° F. (29.4° C.), the coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 2 mL/min and a nozzle atomizing nitrogen pressure of 15 psi. After the entire coating material carrier medium was atomized, the pump was turned off and the fluidized bed was maintained at 160° F. (71.1° C.) for 5 min to dry the coated microspheres. Then, the heater was turned off and the fluidized bed was maintained for another 5 min to cool the coated microspheres.

The coated microspheres were collected and then sieved using a 212 μm screen to separate them from the cofluidization particles. Upon examination with a microscope, the microspheres were observed to be coated with a blue layer.

### Example 3

### Coating of Water-Swellable Hydrogel Microspheres with Sucrose to Smooth the Surface of the Microspheres

The purpose of this Example was to demonstrate coating of water-swellable hydrogel microspheres with a surface-smoothing layer of sucrose.

A coating material carrier medium was prepared by mixing 5 g of red food coloring dye, 25 g of sucrose, and 474.5 g of deionized water in a 1-L beaker using a magnetic stirrer until a homogeneous solution was obtained.

A dry mixture was prepared by mixing together 36 g of the starting microspheres (unsieved having a preselected diameter range of about 25 μm to about 250 μm), prepared using the method described in General Methods, and 230 g of polystyrene cofluidization particles having a diameter range of 425 to 500 μm, density of 1.05 g/cm³ (Norstone Inc., Wyncote, Pa.). The polystyrene cofluidization particles were sieved with a 425 μm screen to obtain the desired size range.

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 53 feet/min with an inlet heating temperature set at 160° F. (71.1° C.) to form a fluidized bed.

When the outlet gas temperature reached 85° F. (29.4° C.), the coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 1 mL/min and a nozzle atomizing nitrogen pressure of 15 psi. After the entire coating material carrier medium was atomized, the pump was turned off and the fluidized bed was maintained at 160° F. (71.1° C.) for 2 min to dry the coated microspheres. Then, the heater was turned off and the fluidized bed was maintained for another 6 min to cool the coated microspheres.

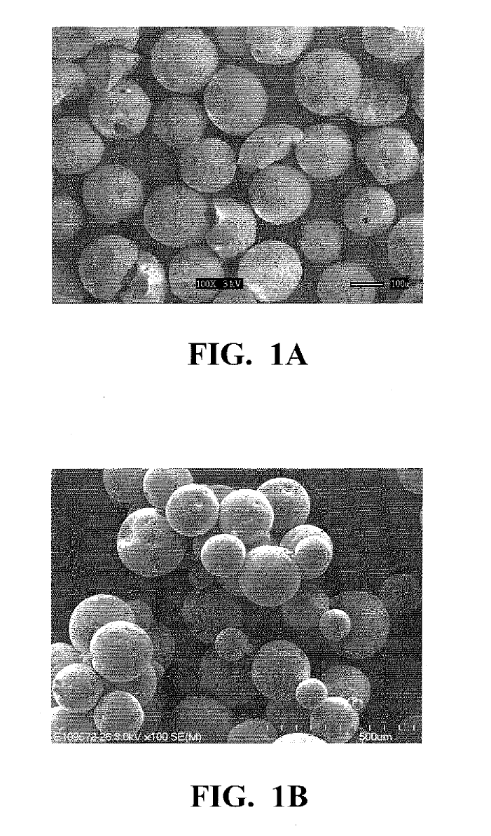

The coated microspheres were collected and then sieved using a 212 μm screen to separate them from the cofluidization particles. As shown in the electron micrographs in FIG. 1, the coated microspheres (A) had a smoother surface than the uncoated microspheres (B).

### Example 4

### Coating of Water-Swellable Hydrogel Microspheres with a Drug

The purpose of this Example was to demonstrate coating of water-swellable hydrogel microspheres with a low molecular weight drug (i.e., aspirin).

A coating material carrier medium was prepared by mixing 5 g of aspirin, 2 g of red food coloring dye, and 493 g of deionized water in a 1-L beaker. The mixture was stirred at 50° C. using a magnetic stirrer until the aspirin dissolved.

A dry mixture was prepared by mixing together 25.5 g of the starting microspheres (unsieved having a preselected diameter range of about 25 μm to about 250 μm), prepared using the method described in General Methods, and 225 g of polystyrene cofluidization particles having a diameter range of 425 to 500 μm, density of 1.05 g/cm³ (Norstone Inc., Wyncote, Pa.). The polystyrene cofluidization particles were sieved using a 425 μm screen to obtain the desired size range.

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 55 feet/min with an inlet heating temperature set at 160° F. (71.1° C.) to form a fluidized bed.

When the outlet gas temperature reached 85° F. (29.4° C.), the coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 2 mL/min and a nozzle atomizing nitrogen pressure of 15 psi. After the entire coating material carrier medium was atomized, the pump was turned off and the fluidized bed was maintained at 160° F. (71.1° C.) for 10 min to dry the coated microspheres. Then, the heater was turned off and the fluidized bed was maintained for another 10 min to cool the coated microspheres. The coated microspheres were collected and then sieved using a 250 μm screen to separate them from the cofluidization particles.

The release of aspirin from the coated hydrogel microspheres was determined using a spectrophotometric method. Three samples of the aspirin coated microspheres and uncoated control microspheres (approximately 20 mg each) were weighed into separate 2 mL microfuge tubes and 1.5 mL of PBS buffer was added to each tube. The tubes were incubated in a shaker bath set at 37° C. and 80 rpm. At various release measurement time points, the tubes were centrifuged at 13,000×g for 5 min and then approximately 1.4 mL of liquid sample was removed from the tubes and replaced with an equivalent amount of fresh PBS. The tubes were returned to the shaker bath. The collected samples were stored at −20° C. until the time of analysis. The amount of aspirin in the samples was determined spectrophotometrically by measuring the absorbance at 530 nm of a complex of aspirin with iron (III) as follows. To a 500 μL aliquot of each sample in a 2 mL microfuge tube, was added 0.5 mL of 2 M sodium hydroxide solution. The resulting sample mixtures were heated in a heating block at 100° C. for 15 min. After that time, 0.6 μL of each of the sample mixtures was added to 14.4 μL of water in a well of a 96-well round-bottom polystyrene plate, and 285 μL of 0.02 M FeCl₃ solution was added to each well. The absorbance of each sample was measured at 530 nm using a SpectraMax 384 Plus spectrophotometer (Molecular Devices, Sunnyvale, Calif.). For each time point, the background absorbance from a sample of microspheres not coated with aspirin was subtracted and the amount of aspirin in each sample was determined from a standard curve of samples of known aspirin concentration.

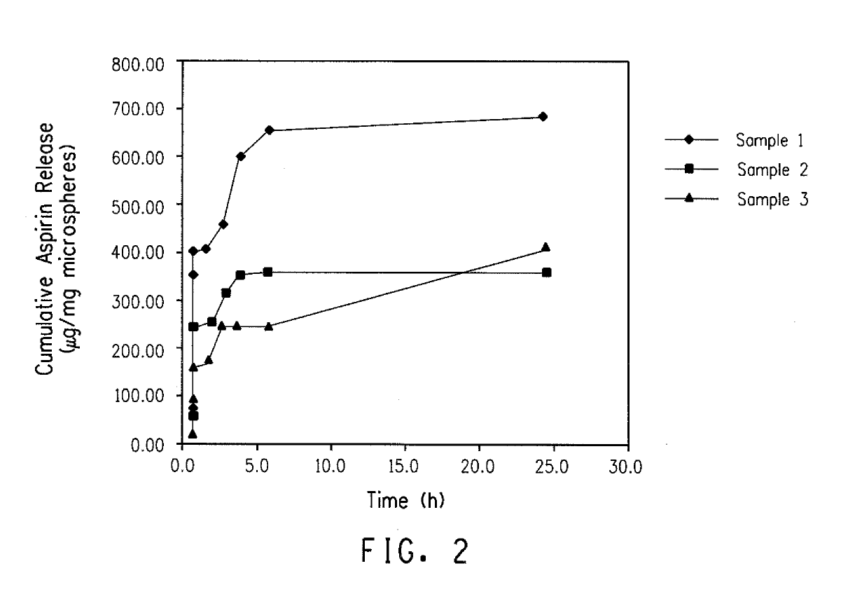

The cumulative release profile for the three samples is shown in FIG. 2. As can be seen from the figure, for all three samples, the release of aspirin from the coated microspheres was substantially completed after 5 h. The results demonstrate that hydrogel microspheres can be coated with a low molecular weight molecule for drug delivery applications using the method disclosed herein.

### Example 5

### Coating of Water-Swellable Hydrogel Microspheres with a Protein

The purpose of this Example was to demonstrate coating of water-swellable hydrogel microspheres with a large protein molecule (i.e., BSA).

A coating material carrier medium was prepared by mixing 5 g of BSA and 100 g of deionized water in a 1-L beaker using a magnetic stirrer until a homogeneous solution was obtained.

A dry mixture was prepared by mixing together 27 g of the starting microspheres (unsieved having a preselected diameter range of about 25 μm to about 250 μm), prepared using the method described in General Methods, and 225 g of polystyrene cofluidization particles having a diameter range of 425 to 500 μm, density of 1.05 g/cm³ (Norstone Inc., Wyncote, Pa.). The polystyrene cofluidization particles were sieved using a 425 μm screen to obtain the desired size range.

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 45 feet/min with an inlet heating temperature set at 122° F. (50° C.) to form a fluidized bed.

When the outlet gas temperature reached 80° F. (26.7° C.), the coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 1 mL/min and a nozzle atomizing nitrogen pressure of 15 psi. After the entire coating material carrier medium was atomized, the pump was turned off and the fluidized bed was maintained at 122° F. (50° C.) for 5 min to dry the coated microspheres. Then, the heater was turned off and the fluidized bed was maintained for another 10 min to cool the coated microspheres. The coated microspheres were collected and then sieved using a 250 μm screen to separate them from the cofluidization particles.

The release of BSA from the coated microspheres was determined using a protein assay. Three samples of the BSA coated microspheres (approximately 13 mg each) were weighed into separate 2 mL microfuge tubes and 1.5 mL of PBS buffer was added to each tube. The tubes were incubated in a shaker bath set at 37° C. and 80 rpm. At various release measurement time points, the tubes were centrifuged at 13,000×g for 5 min and then approximately 1.4 mL of liquid sample was removed from the tubes and replaced with an equivalent amount of fresh PBS. The tubes were returned to the shaker bath. The collected samples were diluted 1:5 with PBS and assayed using the BCA protein assay (Pierce, Rockford, Ill.) to determine the amount of BSA in each sample.

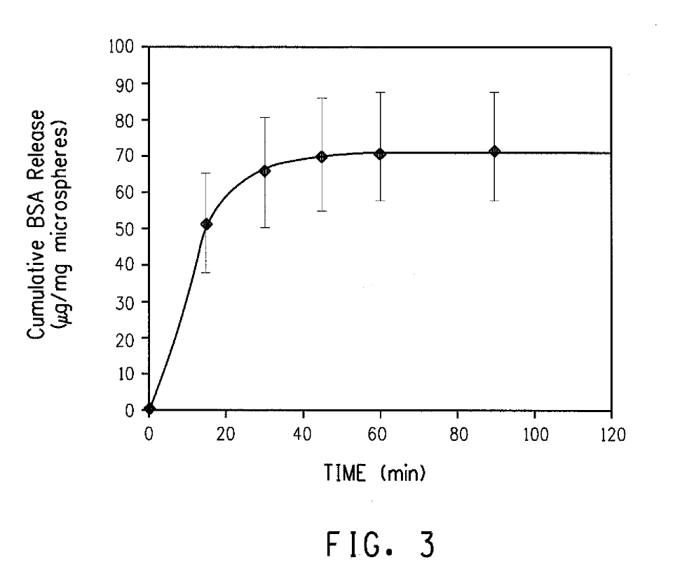

The cumulative release profile, plotted as the average of the three samples with standard deviation bars, is shown in FIG. 3. As can be seen from FIG. 3, the BSA was released within about 1 h. The results demonstrate that hydrogel microspheres can be coated with a large protein molecule using the method disclosed herein.

### Example 6

### Coating of Water-Swellable Hydrogel Microspheres with a Protein and a Polymer Barrier Layer

The purpose of this Example was to demonstrate coating of water-swellable hydrogel microspheres with a large protein molecule (i.e., BSA) and a barrier layer of polyacrylic acid.

A first coating material carrier medium was prepared by mixing 5 g of BSA and 95 g of deionized water in a 1-L beaker using a magnetic stirrer until a homogeneous solution was obtained.

A second coating material carrier medium was prepared as follows. Into a flask was added 480 g of distilled water, 20 g of acrylic acid, and 1.0 g of N,N′-methylenebisacrylamide. These ingredients were stirred for approximately 15 min to ensure complete mixing, and then 0.05 g of VA-044 azo initiator was added to the resulting solution immediately prior to use.

A dry mixture was prepared by mixing together 25 g of the starting microspheres (unsieved having a preselected diameter range of about 25 μm to about 250 μm), prepared using the method described in General Methods, and 225 g of polystyrene cofluidization particles having a diameter range of 425 to 500 μm, density of 1.05 g/cm³ (Norstone Inc., Wyncote, Pa.). The polystyrene cofluidization particles were sieved using a 425 μm screen to obtain the desired size range.

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 38 feet/min with an inlet heating temperature set at 150° F. (65.5° C.) to form a fluidized bed.

When the outlet gas temperature reached 80° F. (26.7° C.), the first coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 1 mL/min and a nozzle atomizing nitrogen pressure of 15 psi. After the entire coating material carrier medium was atomized, the pump was turned off and the fluidized bed was maintained at 150° F. (65.5° C.) for 5 min to dry the coated microspheres. Then, the heater was turned off and the fluidized bed was maintained for another 4 min to cool the coated microspheres.

The fluidized bed was formed again using a stream of flowing nitrogen gas having a velocity of 55 feet/min with an inlet heating temperature set at 150° F. (65.5° C.). When the outlet gas temperature reached 100° F. (37.8° C.), the second coating material carrier medium was atomized by pumping the solution into the fluidized bed through an atomizing nozzle using a liquid pump at a rate of 1 mL/min and a nozzle atomizing nitrogen pressure of 15 psi. After the entire coating material carrier medium was atomized, the pump was turned off and the fluidized bed was maintained at 150° F. (65.5° C.) for 10 min to dry the coated microspheres. Then, the heater was turned off and the fluidized bed was maintained for another 10 min to cool the coated microspheres. The coated microspheres were collected and then sieved using a 250 μm screen to separate them from the cofluidization particles.

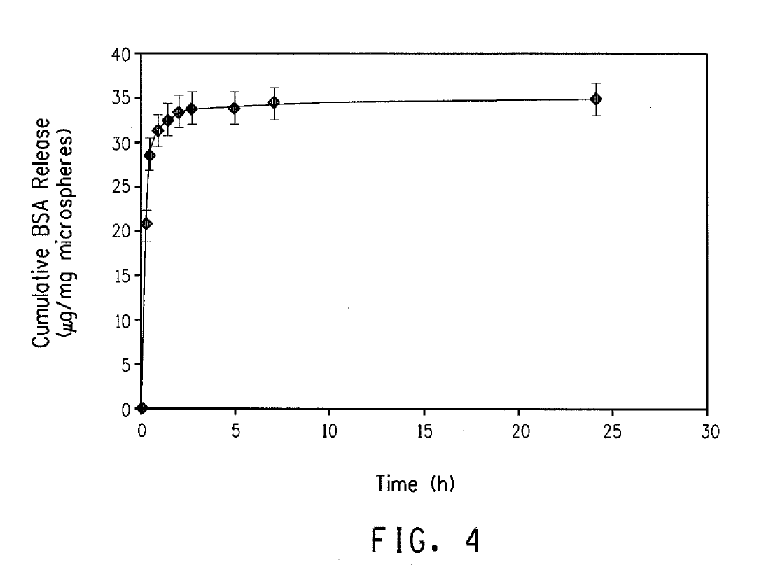

The release of BSA from the coated microspheres was determined using a protein assay as described in Example 5. The cumulative release profile, plotted as the average of three samples with standard deviation bars, is shown in FIG. 4. As can be seen from the figure, the BSA was released within about 2 h, one hour longer than the release time for the BSA coated microspheres described in Example 4, which did not have the polymer barrier layer. The results demonstrate that hydrogel microspheres can be coated with a large protein molecule and a polymer barrier layer to slow release using the method disclosed herein.

### Example 7

### Coating of Water-Swellable Hydrogel Microspheres with a Drug and Polymer Barrier Layers

The purpose of this Example was to demonstrate coating of water-swellable hydrogel microspheres with a small drug molecule (i.e., aspirin) and barrier layers of ethylcellulose and polyacrylic acid.

A first coating material carrier medium was prepared by mixing 5 g of aspirin, 20 g of ethanol (as co-solvent), and 480 g of deionized water in a 1-L beaker. The mixture was stirred at 50° C. using a magnetic stirrer until the aspirin dissolved.

A second coating material carrier medium was prepared by mixing 425 g of Aquacoat® ECD, 31.6 g of dibutyl sebacate (DBS) plasticizer (Morflex, Inc., Greensboro, N.C.), and 88 g of deionized water using a magnetic stirrer until a homogeneous solution was obtained.

A third coating material carrier medium was prepared as follows. Into a flask was added 475 g of distilled water, 25 g of acrylic acid, and 1.25 g of N,N′-methylenebisacrylamide. These ingredients were stirred for approximately 15 min to ensure complete mixing, and then 0.0625 g of VA-044 azo initiator was added to the resulting solution immediately prior to use.

A dry mixture was prepared by mixing together 25 g of the starting microspheres (unsieved having a preselected diameter range of about 25 μm to about 250 μm), prepared using the method described in General Methods, and 225 g of polystyrene cofluidization particles having a diameter range of 425 to 500 μm, density of 1.05 g/cm³ (Norstone Inc., Wyncote, Pa.). The polystyrene cofluidization particles were sieved using a 425 μm screen to obtain the desired size range.

The dry mixture was placed into a Wurster Coater (Laboratory Fluid Bed Granulator/Coater Model 100N, Applied Chemical Technology Inc., Florence, Ala.) and exposed to a stream of flowing nitrogen gas having a velocity of 55 feet/min with an inlet heating temperature set at 160° F. (71.1° C.) to form a fluidized bed.

When the outlet gas temperature reached 100° F. (37.8° C.), the first coating material carrier medium was atomized by pumping the solution into the fluidized bed through an atomizing nozzle using a liquid pump (Masterflex® L/S® digital standard drive, Cole-Parmer Instrument Company, Vernon Hills, Ill.) at a rate of 1 mL/min and a nozzle atomizing nitrogen pressure of 15 psi.

After 118 g of the first coating material carrier medium was atomized, a sample of microspheres was collected for analysis (Sample A). Then, the second coating material carrier medium was atomized by pumping the solution into the fluidized bed through an atomizing nozzle using a liquid pump at a rate of 1 mL/min and a nozzle atomizing nitrogen pressure of 15 psi. After 270 g of the second coating material carrier medium was atomized, a sample of microspheres was collected for analysis (Sample B). Then, another 270 g of the second coating material carrier medium was atomized by pumping the solution into the fluidized bed through an atomizing nozzle using a liquid pump at a rate of 1 mL/min and a nozzle atomizing nitrogen pressure of 15 psi. After completion of the atomization of the second coating material carrier medium, another sample of microspheres was collected for analysis (Sample C).

Then, the third coating material carrier medium was atomized by pumping the solution into the fluidized bed through an atomizing nozzle using a liquid pump at a rate of 1 mL/min and a nozzle atomizing nitrogen pressure of 15 psi. After 200 g of the third coating material carrier medium was atomized, a sample of microspheres was collected for analysis (Sample D). Then, the pump was turned off and the fluidized bed was maintained at 160° F. (71.1° C.) for 10 min to dry the coated microspheres. Then, the heater was turned off and the fluidized bed was maintained for another 10 min to cool the coated microspheres. The coated microspheres were collected and then sieved using a 250 μm screen to separate them from the cofluidization particles.

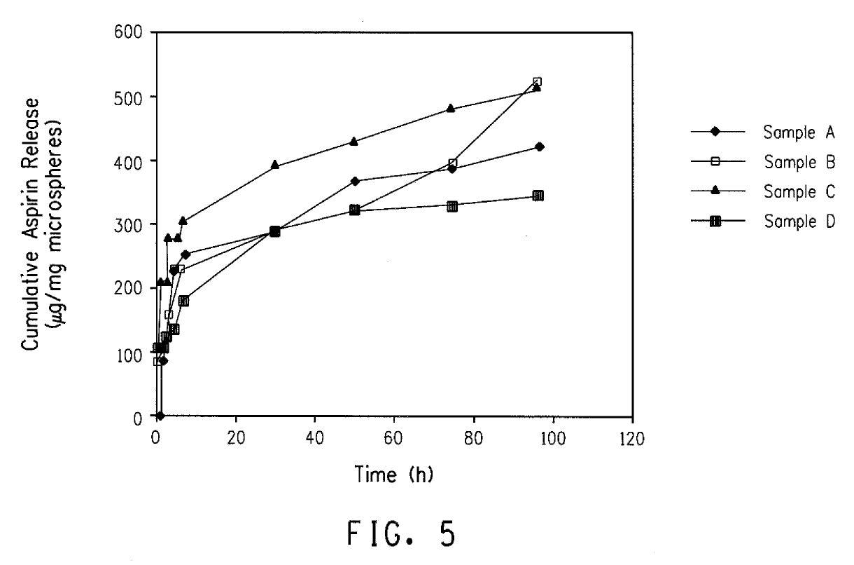

The release of aspirin from the coated hydrogel microsphere samples A, B, C, and D was determined using a spectrophotometric method, as described in Example 4. The results are shown in FIG. 5. As can be seen from the figure, the two samples of microspheres coated with Aquacoat® (Samples B and C) did not exhibit significantly delayed release compared to the aspirin only coated microspheres (Sample A). The reason for this may be that the Aquacoat® layer was not cured after coating. The polyacrylic acid layer provided some delayed release of the aspirin (Sample D).

What is claimed is:

1. A process for making coated water-swellable, substantially water-free hydrogel microspheres from starting microspheres having a preselected diameter range from dₘᵢₙ to dₘₐₓ, and a preselected swell initiation time with a nonvolatile coating material comprising the steps of:
(a) providing a coating material carrier medium by mixing the coating material with an aqueous medium comprising volatile components;
(b) providing a dry mixture comprising the starting microspheres and cofluidization particles having a diameter range from Dₘᵢₙ to Dₘₐₓ, wherein Dₘᵢₙ is at least larger than dₘₐₓ and a density that allows the dry mixture to form a fluidized bed in step (c);
(c) exposing the dry mixture to a stream of flowing gas in a chamber at a temperature sufficiently high to evaporate the volatile components of the aqueous medium in a time less than the preselected swell initiation time, thereby forming the fluidized bed comprising the dry mixture;
(d) atomizing the coating material carrier medium into the chamber containing the fluidized bed for a time sufficient to provide the coated microspheres; and
(e) optionally repeating step (d) one or more times with the same or different coating material carrier medium; and
(f) separating the coated microspheres from the cofluidization particles.

2. The process according to claim 1 wherein the starting microspheres comprise at least one monomer selected from the group consisting of acrylic acid, methacrylic acid, salts of acrylic acid and methacrylic acid, acrylamide, methacrylamide, N-substituted acrylamides, N-substituted methacrylamides, vinyl alcohol, vinyl acetate, methyl maleate, 2-acryloylethane-sulfonic acid, 2-methacryloylethane-sulfonic acid, salts of 2-acryloylethane-sulfonic acid and 2-methacryloylethane-sulfonic acid, styrene-sulfonic acid, salts of styrene-sulfonic acid, 2-hydroxyethyl acrylate, 2-hydroxyethyl methacrylate, isobutylene, maleic anhydride, acrylonitrile, and ethylene glycol.

3. The process according to claim 2 wherein the starting microspheres comprise acrylic acid and at least one monomer selected from the group consisting of sodium acrylate, 2-hydroxyethyl methacrylate, 2-hydroxyethyl acrylate, styrene sulfonic acid, and the sodium salt of styrene sulfonic acid.

4. The process according to claim 3 wherein the starting microspheres comprise acrylic acid and sodium acrylate.

5. The process according to claim 2 wherein the starting microspheres comprise styrene sulfonic acid or a combination comprising styrene sulfonic acid and the sodium salt of styrene sulfonic acid.

6. The process according to claim 2 wherein the starting microspheres comprise acrylic acid, sodium acrylate and vinyl alcohol.

7. The process according to claim 1 wherein the coating material is selected from the group consisting of a drug, a therapeutic agent, a biological material, a hydrophilic polymer, a hydrophobic polymer, a monomer, a marker, a carbohydrate, a polysaccharide, a wax, an inorganic material, and combinations thereof.

8. The process according to claim 1 wherein the coating material is selected from the group consisting of a fertilizer, a herbicide, a pesticide, and a cosmetic agent.

9. The process according to claim 1 wherein the cofluidization particles are comprised of materials selected from the group consisting of polymers, metallic coated particles, metal oxides, and glasses.

10. The process according to claim 1 wherein the cofluidization particles are polystyrene particles.

11. The process according to claim 1 wherein the aqueous medium is water.

12. The process according to claim 1 wherein the starting microspheres have a preselected diameter range from dₘᵢₙ of 20 microns to dₘₐₓ of 800 microns.

13. The process according to claim 1 wherein the cofluidization particles have a diameter range from Dₘᵢₙ of 100 microns to Dₘₐₓ of 1,000 microns.
